(19) United States
(12) Patent Application Publication
(10) Pub. No.: US 2006/0205446 A1
(43) Pub. Date: Sep. 14, 2006

(54) Display apparatus

(76) Inventors: Jong-Nam Lee, Anyang-si (KR); Young-Bee Chu, Suwon-si (KR); Sang-Hee Lee, Yongin-si (KR); Dong-Cheol Kim, Suwon-si (KR); Jae-Lok Cha, Goyang-si (KR); Jeong-Min Seo, Seoul (KR)

Correspondence Address: MacPherson Kwok Chen & Heid LLP, Suite 210, 2402 Michelson Drive, Irvine, CA, 92612, US

(21) Appl. No.: 11/325,842

(22) Filed: Jan. 4, 2006

(30) Foreign Application Priority Data
Jan. 4, 2005 (KR) 2005-00544

(51) Int. Cl. H04M 1/00

(52) U.S. Cl. 455/575.1; 400/615.2

(57) ABSTRACT

In a display apparatus, a housing unit includes a front case having an opening and a rear case being coupled to the front case. In some embodiments, a receiving container is in the housing unit, and includes a sidewall having a first fixture portion protruded from the sidewall and extended toward an inner side face of the housing unit. A display panel is positioned in the housing unit, and has a display area corresponding to the opening. In some embodiments, a chassis includes a first chassis portion and a second chassis portion. A first chassis portion is on an edge portion of the display panel. A second chassis portion includes a second fixture portion extended from the first chassis portion along a sidewall of the receiving container, and the second fixture portion is protruded toward the inner side face of the housing unit. The display apparatus may have a compact size.

### CROSS-REFERENCE TO RELATED APPLICATION

This application relies for priority upon Korean Patent Application No. 2005-00544, filed on Jan. 4, 2005, the contents of which are herein incorporated by reference in their entirety.

### BACKGROUND OF THE INVENTION

1. Field of the Invention

The present invention relates to a display apparatus. More particularly, the present invention relates to a display apparatus of which weight and volume are reduced.

2. Description of the Related Art

In general, a display apparatus converts data that is processed in an information processing device into an image.

Liquid crystal display devices are relative thin and lightweight compared to cathode ray tube (CRT) display devices. As a result, liquid crystal displays are widely used for electronic devices such as portable computers and other information processing devices such as personal data assistants or PDAs, communication devices (such as cellular telephones), televisions, and aerospace devices.

Liquid crystal display panels are fragile, since they are typically formed on a glass substrate. Therefore, liquid crystal display panels are generally mounted in a housing, and coupled to the information processing device. For example, a display portion of the liquid crystal display panel incorporated in a mobile instrument such as cellular phone is received in a housing. The housing has an opening corresponding to the display portion, and is coupled to a body of the communication device. In order to protect the display panel, the display apparatus has a window adjacent to the opening.

Although the window protects the display panel from being damaged, incorporating a window also increases the size and volume of the display apparatus.

### SUMMARY OF THE INVENTION

Systems and techniques provided herein may provide a display apparatus in which the display panel is protected, but with reduced size and weight.

In general, in one aspect, a display apparatus comprises a display panel assembly including a display panel, the display panel configured to display an image in response to receiving one or more signals indicative of image information. The display panel assembly may include a display area and a peripheral area, the display panel assembly including a fixture assembly adjacent the peripheral area. The apparatus further comprises a housing configured to house a display panel assembly, where the housing comprising a first housing portion including an opening, the opening substantially aligned with the display area of the display panel. The housing may further comprise a second housing portion attached to the first housing portion, and at least one of the first housing portion and the second housing portion are attached to the fixture assembly of the display panel assembly.

In some embodiments, the housing does not include a window covering the opening. In some embodiments, the display panel assembly further includes another fixture assembly. The fixture assembly may be positioned adjacent a first sidewall of the display panel, while the another fixture assembly may be positioned adjacent a second sidewall of the display panel opposite the first sidewall. At least one of the first housing portion and the second housing portion may be attached to the fixture assembly and the another fixture assembly. Both the first housing portion and the second housing portion may be attached to the fixture assembly, for example, using a mechanical attachment apparatus.

The display panel apparatus may further comprise a receiving container, and the display panel may be positioned in the receiving container. The fixture assembly may be attached to the receiving container. The display panel apparatus may further comprises a mold frame positioned in the receiving container, and the display panel may be positioned in the mold frame.

In general, in another aspect, a display apparatus includes a housing unit, a display panel and a fixture member. The housing unit includes a front case having an opening and a rear case being coupled to the front case. The display panel is received in the housing unit, and the display panel has a display area corresponding to the opening. The fixture member is between an inner side face of the housing unit and a sidewall of the display panel, and the fixture member fixes the display panel to the housing unit.

In another aspect of the present invention, a display apparatus includes a housing unit, a receiving container and a display panel. The housing unit includes a front case having an opening and a rear case being coupled to the front case. The receiving container is positioned in the housing unit, and the receiving container includes a sidewall having a fixture portion protruded from the sidewall and extended toward an inner side face of the housing unit. The display panel is positioned in the housing unit, so that a display area of the display area is substantially aligned with the opening.

In still another aspect of the present invention, a display apparatus includes a housing unit, a receiving container, a display panel and a chassis. The housing unit includes a front case including an opening and a rear case being coupled to the front case. The receiving container is positioned in the housing unit and comprises a sidewall. The display panel is positioned in the housing unit, and the display panel including a display area positioned adjacent to the opening. The chassis includes a first chassis portion and a second chassis portion. The first chassis portion is positioned adjacent an edge portion of the display panel. The second chassis portion includes a fixture portion extended from the first chassis portion along a sidewall of the receiving container, and the fixture portion protrudes toward an inner side face of the housing unit to be coupled to the housing unit.

In still another aspect of the present invention, a display apparatus includes a housing unit, a receiving container, a display panel and a chassis. The housing unit includes a front case having an opening and a rear case being coupled to the front case. The receiving container is positioned in the housing unit, and the receiving container includes a sidewall unit including a sidewall and a first fixture portion protruding from the sidewall and extending toward an inner side face of the housing unit. The display panel is positioned in the housing unit, and the display panel has a display area corresponding to the opening. The chassis includes a first chassis portion and a second chassis portion. The first chassis portion is positioned adjacent an edge portion of the display panel. The second chassis portion includes a second fixture portion extended from the first chassis portion along a sidewall of the receiving container, and the second fixture portion is protruded toward the inner side face of the housing unit to be coupled to the housing unit.

According to the above, the display apparatus may have a relatively small size and be lightweight.

### BRIEF DESCRIPTION OF THE DRAWINGS

The above and other advantages of the present invention will become readily apparent by reference to the following detailed description when considered in conjunction with the accompanying drawings wherein:

FIG. 1 is a perspective view illustrating a mobile device including a display apparatus in accordance with an embodiment of the present invention;

FIG. 2 is a cross-sectional view taken along a line I-I′ in FIG. 1;

FIG. 3 is an exploded cross-sectional view taken along a line I-I′ in FIG. 1;

FIG. 4 is a perspective view illustrating a display panel with a fixing member in FIG. 3;

FIG. 5 is a cross-sectional view illustrating a display apparatus in accordance with another embodiment of the present invention;

FIG. 6 is an exploded cross-sectional view illustrating the display apparatus in FIG. 5;

FIG. 7 is a cross-sectional view taken along a line II-II′ in FIG. 5;

FIG. 8 is a cross-sectional view illustrating a display apparatus in accordance with still another embodiment of the present invention;

FIG. 9 is an exploded cross-sectional view illustrating the display apparatus in FIG. 8;

FIG. 10 is a perspective view illustrating the display apparatus in FIG. 8;

FIG. 11 is a side view illustrating the display apparatus in FIG. 8;

FIG. 12 is a cross-sectional view illustrating a display apparatus in accordance with still another embodiment of the present invention;

FIG. 13 is an exploded cross-sectional view illustrating a display apparatus in FIG. 12;

FIG. 14 is a perspective view illustrating a display apparatus in FIG. 12; and

FIG. 15 is a side view illustrating a display apparatus in FIG. 12.

### DETAILED DESCRIPTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully describe the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. Further, the presence of a “first” element does not imply that a “second” or other element is needed.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to schematic illustrations of idealized embodiments (and intermediate or other structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

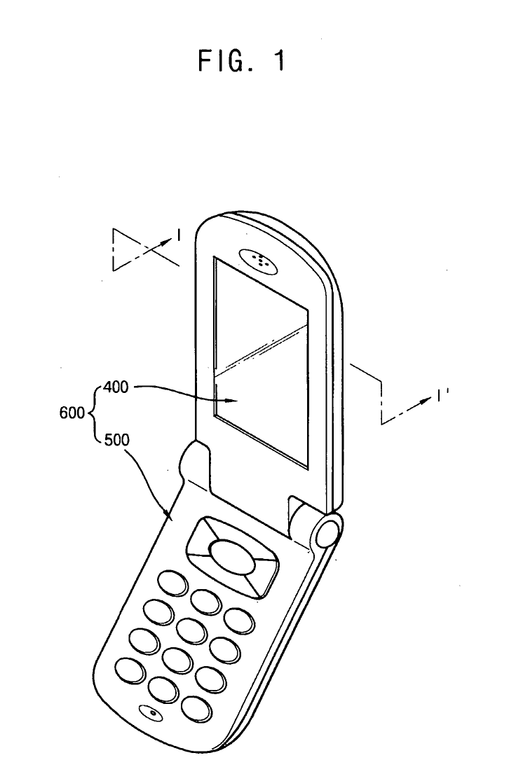

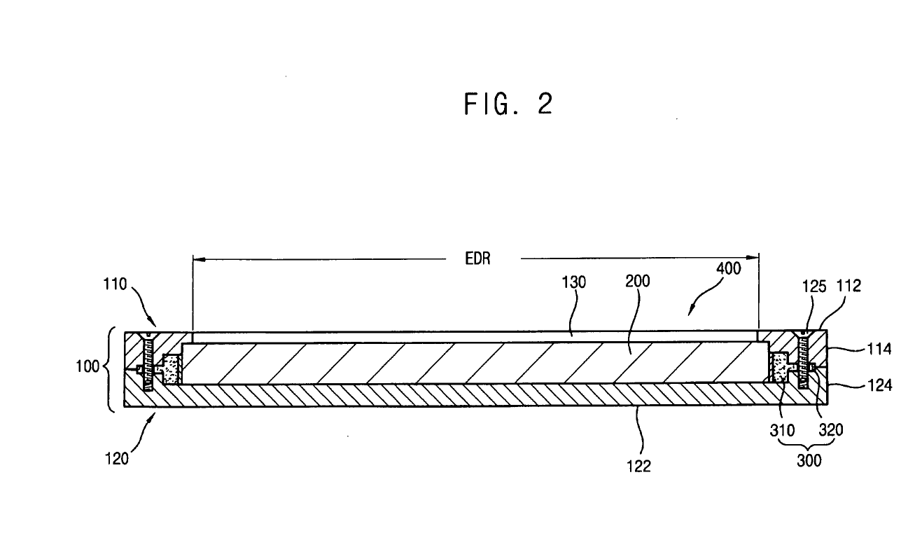

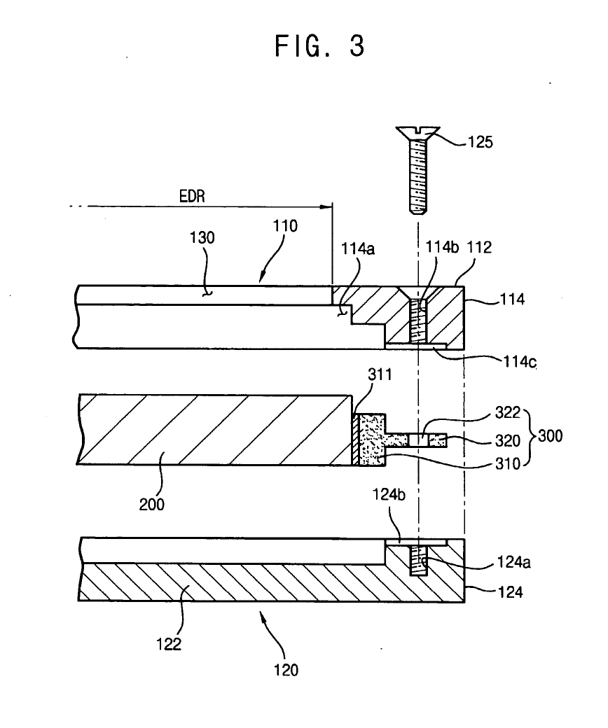

FIG. 1 is a perspective view illustrating a mobile device including a display apparatus in accordance with an embodiment of the present invention. FIG. 2 is a cross-sectional view taken along a line I-I′ in FIG. 1. FIG. 3 is an exploded cross-sectional view taken along a line I-I′ in FIG. 1.

Referring to FIGS. 1 to 3, a communication device 600 includes an information processing apparatus 500 to process communication data and a display apparatus 400 to display an image based on the communication data.

The display apparatus 400 connected to the information processing apparatus 500 includes a housing unit 100, a display panel 200 and a fixing member (fixture) 300.

The housing unit 100 receives the display panel 200 and the fixing member 300. The housing unit 100 includes a front case 110 and a rear case 120.

The front case 110 includes a first front case portion 112 and a second front case portion 114.

The first front case portion 112 has a substantially rectangular frame shape when viewed on a plane. The second front case portion 114 is in a peripheral region of the first front case portion 112. An opening 130 is formed through the first front case portion 112 to expose an effective display region EDR of the display panel 200.

The second front case portion 114 is substantially perpendicular to the first front case portion 112. Also, a stepped portion 114a is formed at the second front case portion 114 to fix the display panel 200 to the front case 110.

The rear case 120 includes a first rear case portion 122 and a second rear case portion 124.

The first rear case portion 122 has a substantially rectangular plate shape, and the second rear case portion 124 is in a peripheral region of the first rear case portion 122 to form a receiving area. The second rear case portion 124 is substantially perpendicular to the first rear case portion 122.

The front case 110 is coupled to the rear case 120. In order to couple the front case 110 to the rear case 120, a first coupling hole 114b is formed through the second front case portion 114 at a position corresponding to the rear case 120. A second coupling hole 124a is formed through the second rear case portion 124 at a position corresponding to the first coupling hole 114b. The first and second coupling holes 114b and 124a are coupled to, for example, a screw 125.

The second front case portion 114 of the front case 110 faces the second rear case portion 124 of the rear case 120. A fixing member (fixture) 300 and the display panel 200 are between the front case 110 and the rear case 120.

The display panel 200 converts the data processed in the information processing apparatus 500 into an image. The display panel 200 may include a liquid crystal display panel to display the image using a liquid crystal.

The display panel 200 is received in the housing unit 100 including the front case 110 and the rear case 120. The fixing member 300 fixes the display panel 200 to the housing unit 100.

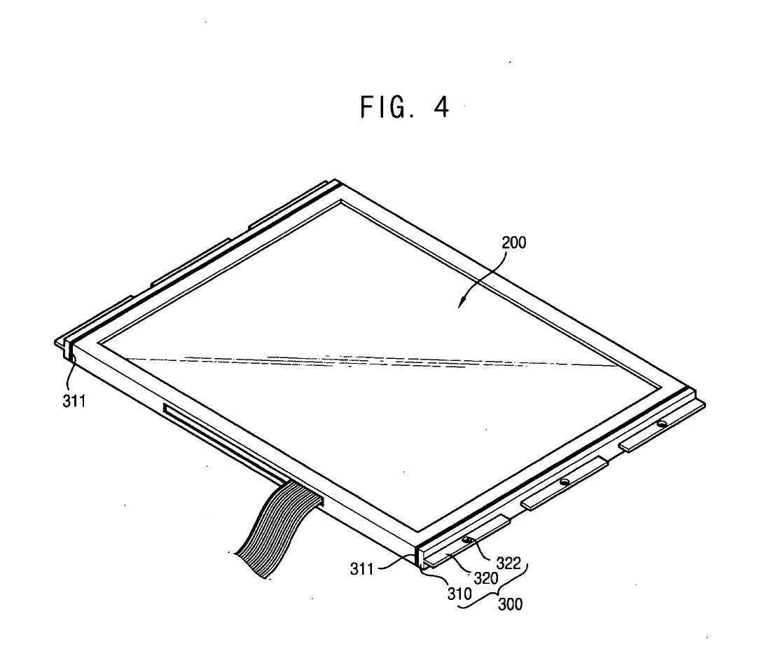

FIG. 4 is a perspective view illustrating a display panel and a fixing member in FIG. 3.

Referring to FIGS. 3 and 4, the fixing member 300 includes a body 310 and a protruding portion 320.

In the embodiment shown in FIG. 4, the body 310 is on one of a pair of opposing sidewalls of the display panel 200. Alternatively, the body 310 may be divided into a plurality of body parts, and the body parts may be on the sidewall in series. The body 310 is coupled to the display panel 200 with an adhesive member 311 formed between the body 310 and the display panel 200.

At least one protruding portion 320 may protrude from the body 310 toward an inner side of the housing unit 100. The protruding portion 320 may have a substantially plate-like shape. The protruding portion 320 is between the second front case portion 114 of the front case 110 and the second rear case portion 124 of the rear case 120. Alternatively, the protruding portion 320 may have an embossed shape. A penetration hole 322 is formed through the protruding portion 320 that is configured to overlap with the second front case portion 114 and the second rear case portion 124. The penetration hole 322 corresponds to the first and second coupling holes 114b and 124a formed of the second front case portion 114 and the second rear case portion 124, respectively. When assembled, the protruding portion 320 is coupled to the screw that is coupled to the first and second coupling holes 114b and 124a.

A first recessed portion 114c is formed at the second front case portion 114 corresponding to the protruding portion 320, which is shaped and sized to receive the protruding portion 320. A second recessed portion 124b is formed at the second rear case portion 124 corresponding to the protruding portion 320 to receive the protruding portion 320. In some embodiments, rather than including recessed portions in both second front case portion 114 and second rear case portion 124, a recess may be formed in one but not the other.

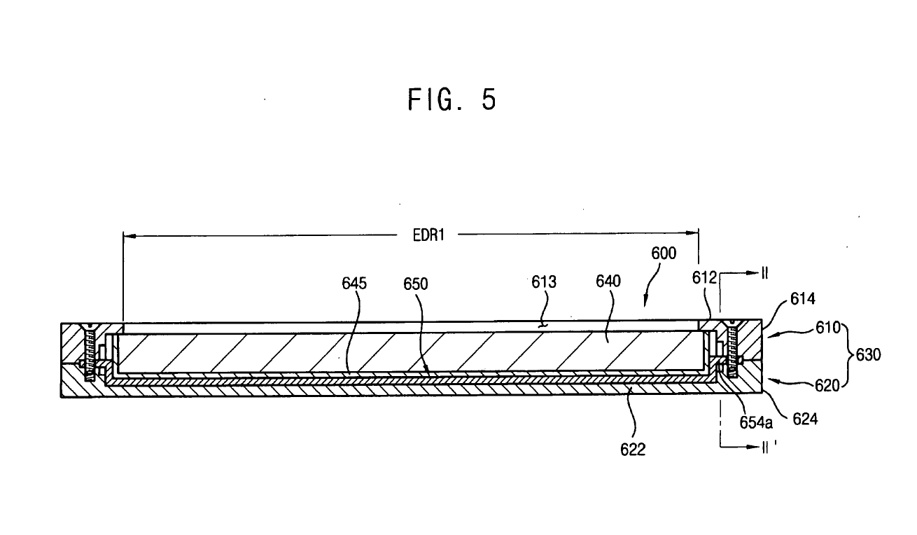

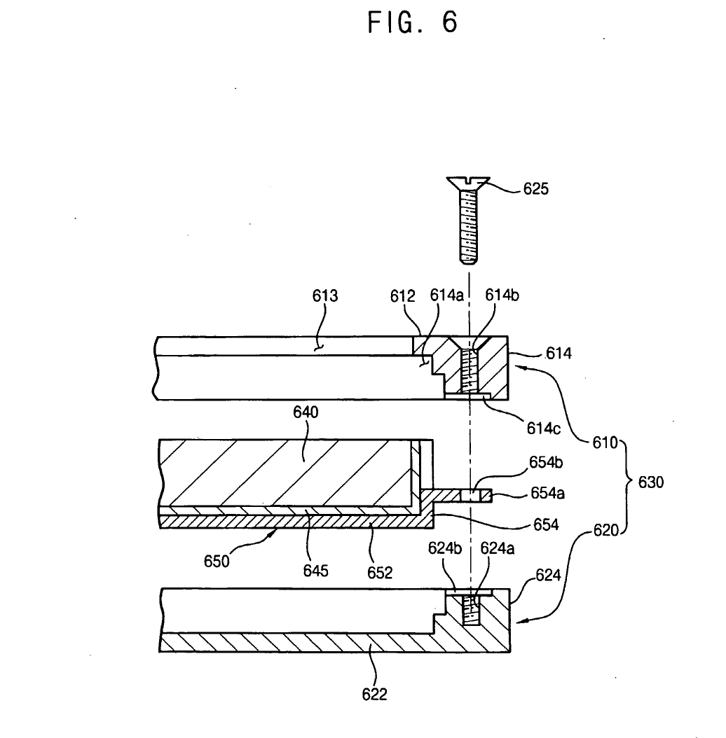

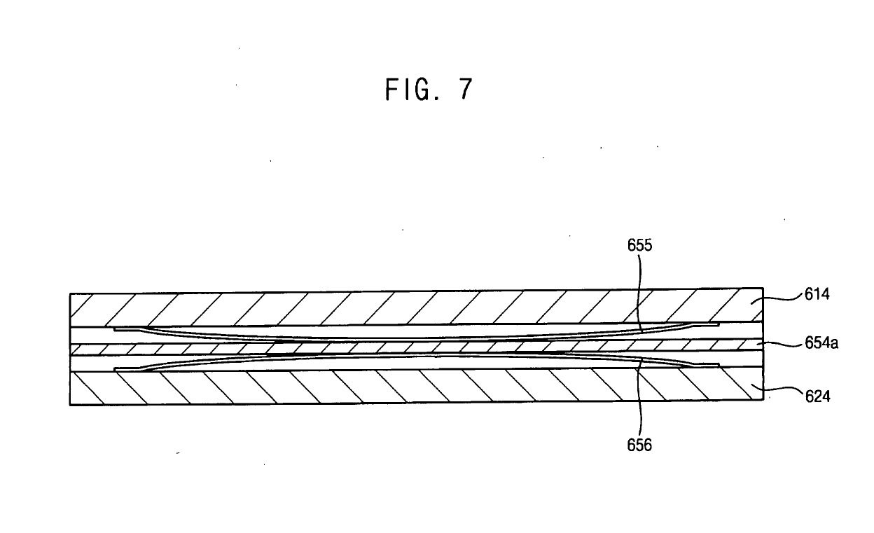

FIG. 5 is a cross-sectional view illustrating a display apparatus in accordance with another embodiment of the present invention. FIG. 6 is an exploded view illustrating the display apparatus in FIG. 5. FIG. 7 is a cross-sectional view taken along a line II-II′ in FIG. 5.

Referring to FIGS. 5 to 7, the display apparatus 600 includes a housing unit 630, a display panel 640 and a receiving container 650.

The housing unit 630 is configured to receive the display panel 640 and the receiving container 650. The housing unit 630 includes a front case 610 and a rear case 620.

The front case 610 includes a first front case portion 612 and a second front case portion 614.

The first front case portion 612 has a substantially rectangular frame shape when viewed on a plane. The second front case portion 614 is in a peripheral region of the first front case portion 612. An opening 613 is formed through the first front case portion 612 to expose an effective display region EDR1 of the display panel 640.

The second front case portion 614 is substantially perpendicular to the first front case portion 612. Additionally, second front case portion 614 includes a stepped portion 614a to fix the display panel 640 and the receiving container 650 to the front case 610.

The rear case 620 includes a first rear case portion 622 and a second rear case portion 624.

The first rear case portion 622 has a substantially rectangular plate shape, and the second rear case portion 624 is in a peripheral region of the first rear case portion 622 and forms a receiving area. The second rear case portion 624 is substantially perpendicular to the first rear case portion 622.

The front case 610 is coupled to the rear case 620. Although many different embodiments are possible, in some embodiments front case 610 may be coupled to rear case 620 using a first coupling hole 614b in the second front case portion 614. A second coupling hole 624a is formed through the second rear case portion 624, at a position corresponding to the position of the first coupling hole 614b. The first and second coupling holes 614b and 624a are coupled to, for example, a screw 625.

The second front case portion 614 of the front case 610 faces the second rear case portion 624 of the rear case 620. The display panel 640 and the receiving container 650 are between the front case 610 and the rear case 620.

The receiving container 650 receives a mold frame 645, and the mold frame 645 receives the display panel 640. The receiving container 650 may include a metal plate, and the mold frame 645 may include a synthetic resin material, etc. The receiving container 650 has a bottom face 652 and a sidewall 654. The mold frame 645 prevents leakage of light through an opening formed on the receiving container 650 by a fixing portion (fixture) 654a of the receiving container 650.

The bottom face 652 is on the first rear case portion 622 of the rear case 620, and the sidewall 654 is in a peripheral region of the bottom face 652. Therefore, a receiving area receiving the display panel 640 is formed on the bottom face 652. The sidewall 654 is formed in the peripheral region of the bottom face 652, and is substantially perpendicular to the bottom face 652.

The fixing portion 654a is formed on the sidewall 654 of the receiving container 650, and the fixing portion 654a has a substantially plate shape. The fixing portion 654a is substantially perpendicular to the sidewall 654, and is substantially parallel to the bottom face 652.

The fixing portion 654a is positioned between the second front case portion 614 and the second rear case portion 624 to fix the receiving container 650 to the front case 610 and the rear case 620. A penetration hole 654b is formed through the fixing portion 654a at a position corresponding to the first coupling hole 614b and the second coupling hole 624a to fix the fixing portion 654a to the second front case portion 614 and the second rear case portion 624. In an embodiment incorporating a screw 625, the fixing portion 654a is fixed between the second front case portion 614 and the second rear case portion 624 using the screw 625, when assembled.

A first recessed portion 614c is formed at the second front case portion 614 corresponding to the fixing portion 654a to receive the fixing portion 654a. A second recessed portion 624b is formed at the second rear case portion 624 corresponding to the fixing portion 654a to receive the fixing portion 654a. In some embodiments, rather than including recessed portions in both second front case portion 614 and second rear case portion 624, a recess may be formed in one but not the other.

Referring to FIG. 7, a first elastic member 655 is positioned between the second front case portion 614 and the fixing portion 654a. A second elastic member 656 is positioned between the fixing portion 654a and the second rear case portion 624. The first and second elastic members 655 and 656 may include a flat-typed spring, a tensile spring, a compression spring, a damper, and/or other elastic apparatus.

The display panel 640 received in the receiving container 650 displays an image based on data processed in an information processing apparatus. The display panel 640 may include a liquid crystal display panel, and may display the image by using a liquid crystal material.

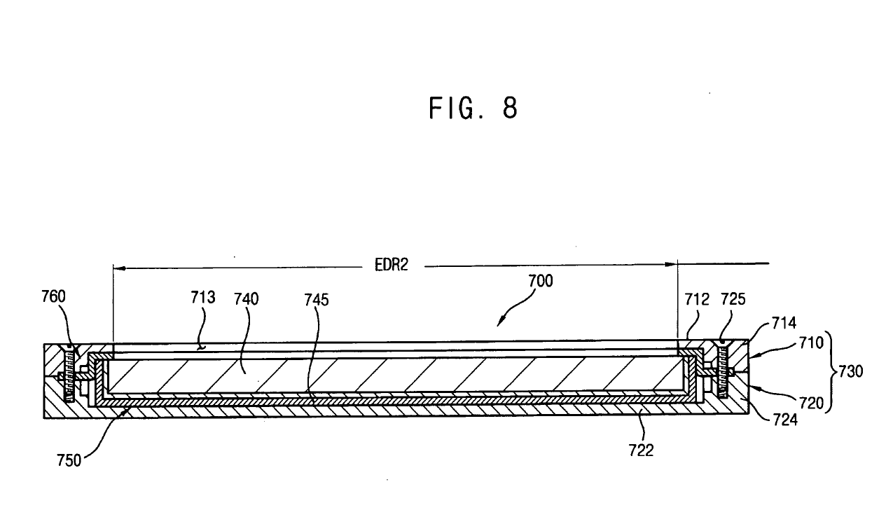

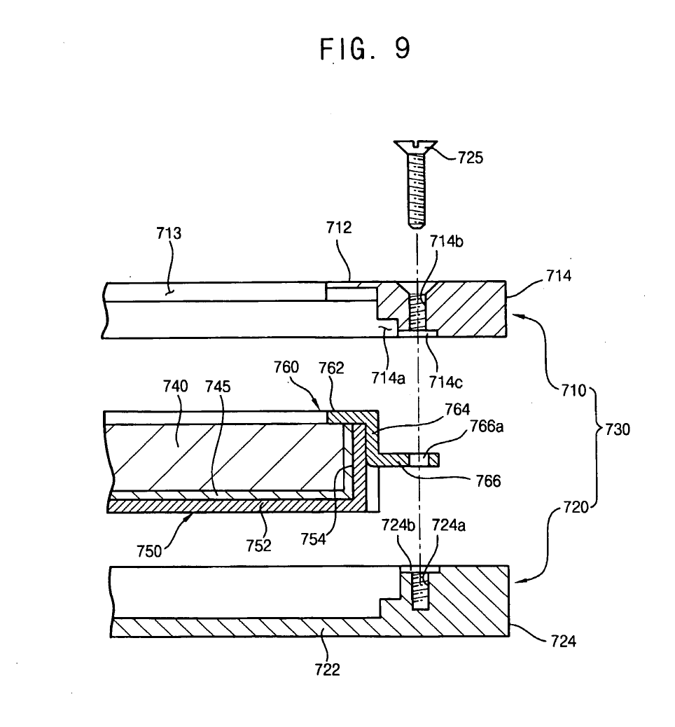

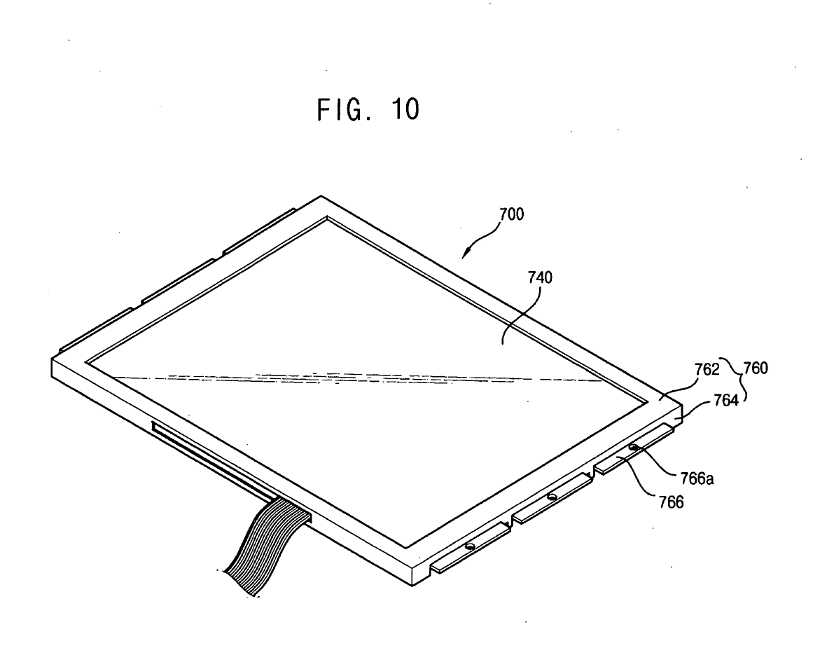

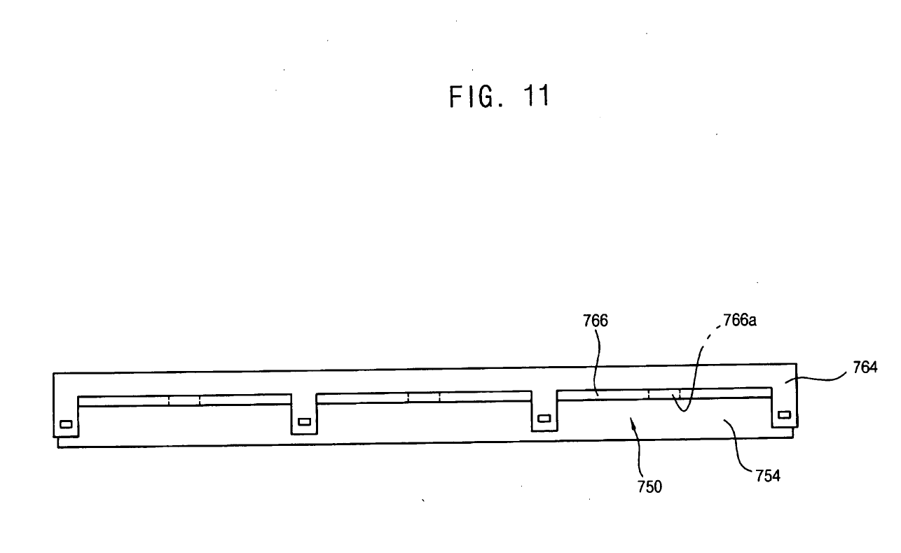

FIG. 8 is a cross-sectional view illustrating a display apparatus in accordance with still another embodiment of the present invention. FIG. 9 is an exploded cross-sectional view illustrating the display apparatus in FIG. 8. FIG. 10 is a perspective view illustrating the display apparatus in FIG. 8. FIG. 11 is a side view illustrating the display apparatus in FIG. 8.

Referring to FIGS. 8 to 11, the display apparatus 700 includes a housing unit 730, a display panel 740, a receiving container 750 and a chassis 760.

The housing unit 730 receives the display panel 740, the receiving container 750 and the chassis 760. The housing unit 730 includes a front case 710 and a rear case 720.

The front case 710 includes a first front case portion 712 and a second front case portion 714.

The first front case portion 712 has a substantially rectangular plate shape when viewed on a plane. The second front case portion 714 is in a peripheral region of the first front case portion 712. First front case portion 712 includes an opening 713, which exposes an effective display region EDR2 of the display panel 740.

The second front case portion 714 is substantially perpendicular to the first front case portion 712. Additionally, second front case portion 714 includes a stepped portion 714a to fix the display panel 740 and receiving container 750 to the front case 710.

The rear case 720 includes a first rear case portion 722 and a second rear case portion 724.

The first rear case portion 722 has a substantially rectangular plate shape, and the second rear case portion 724 is in a peripheral region of the first rear case portion 722 and forms a receiving area. The second rear case portion 724 is substantially perpendicular to the first rear case portion 722.

During assembly of apparatus 700, the front case 710 is coupled to the rear case 720. Although many different embodiments are possible, in some embodiments front case 710 may be coupled to the rear case 720 using a first coupling hole 714b in the second front case portion 714 at a position corresponding to the rear case 720. A second coupling hole 724a is formed through the second rear case portion 724 at a position corresponding to the first coupling hole 714b. The first and second coupling holes 714b and 724a are coupled to, for example, a screw 725.

The second front case portion 714 of the front case 710 faces the second rear case portion 724 of the rear case 720. The display panel 740 and the receiving container 750 are positioned between the front case 710 and the rear case 720.

The receiving container 750 receives a mold frame 745, and the mold frame 745 receives the display panel 740. The receiving container 750 may include a metal plate, and the mold frame 745 may include a synthetic resin material.

The receiving container 750 includes a bottom face 752 and a sidewall 754. The bottom face 752 is on the first rear case portion 722 of the rear case 720, and the sidewall 754 is in a peripheral region of the bottom face 752. Therefore, a receiving area receiving the display panel 740 is formed on the bottom face 752. The sidewall 754 is formed in the peripheral region of the bottom face 752, and is substantially perpendicular to the bottom face 752.

The display panel 740 is positioned in the receiving container 750. The display panel 740 may include a liquid crystal display panel to display the image using a liquid crystal material. Other display panels may be used, such as organic light emitting diode (OLED) display panels.

The chassis 760 is coupled to the receiving container 750 to partially cover the display panel 740, in order to prevent damage to the display panel 740.

The chassis 760 includes a metal plate. The chassis 760 includes a first chassis portion 762 and a second chassis portion 764 having a fixing portion 766.

The first chassis portion 762 is on an edge portion of the display panel 740 to prevent the separation of the display panel 740 from the receiving container 750.

The second chassis portion 764 is connected to the first chassis portion 762, and extends along a direction substantially parallel to the sidewall 754 of the receiving container 750. The second chassis portion 764 may be coupled to the receiving container 750 by a hooking method.

The fixing portion (fixture) 766 is formed on a portion of the second chassis portion 764, and is substantially parallel to the first chassis portion 762. The fixing portion 766 of the chassis 760 is positioned between the second front case portion 714 and the second rear case portion 724. A penetration hole 766a is formed through the fixing portion 766 at a position corresponding to the first coupling hole 714b and the second coupling hole 724a to fix the fixing portion 766 to the second front case portion 714 and the second rear case portion 724. In an embodiment incorporating screw 725, the fixing portion 766 is fixed between the second front case portion 714 and the second rear case portion 724 using the screw 725.

A first recess portion 714c is formed at the second front case portion 714 corresponding to the fixing portion 766 to receive the fixing portion 766. A second recess portion 724b is formed at the second rear case portion 724 corresponding to the fixing portion 766 to receive the fixing portion 766. In some embodiments, rather than including recessed portions in both second front case portion 714 and second rear case portion 724, a recess may be formed in one but not the other.

A first elastic member (not shown) is positioned between the second front case portion 714 and the fixing portion 766. A second elastic member (not shown) is positioned between the fixing portion 766 and the second rear case portion 724. The first and second elastic members may include a flat-typed spring, a tensile spring, a compression spring, a damper, and/or other elastic apparatus.

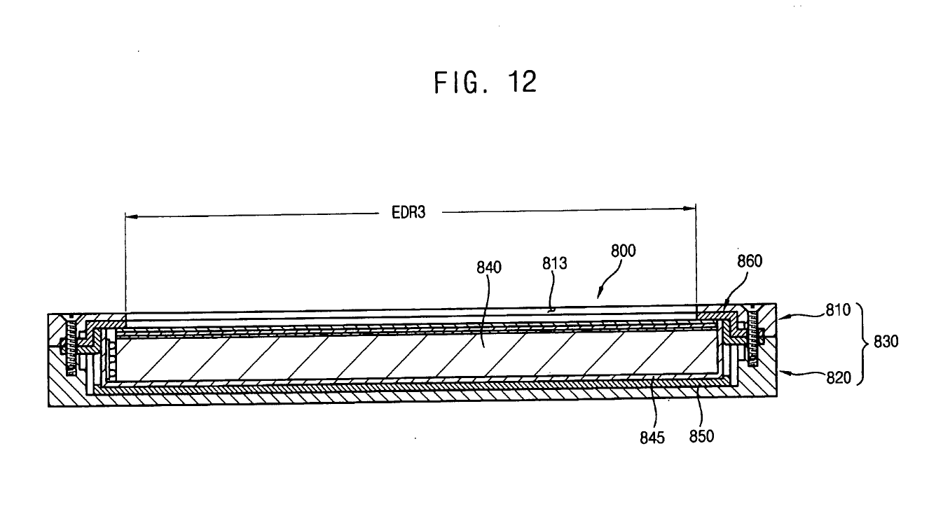

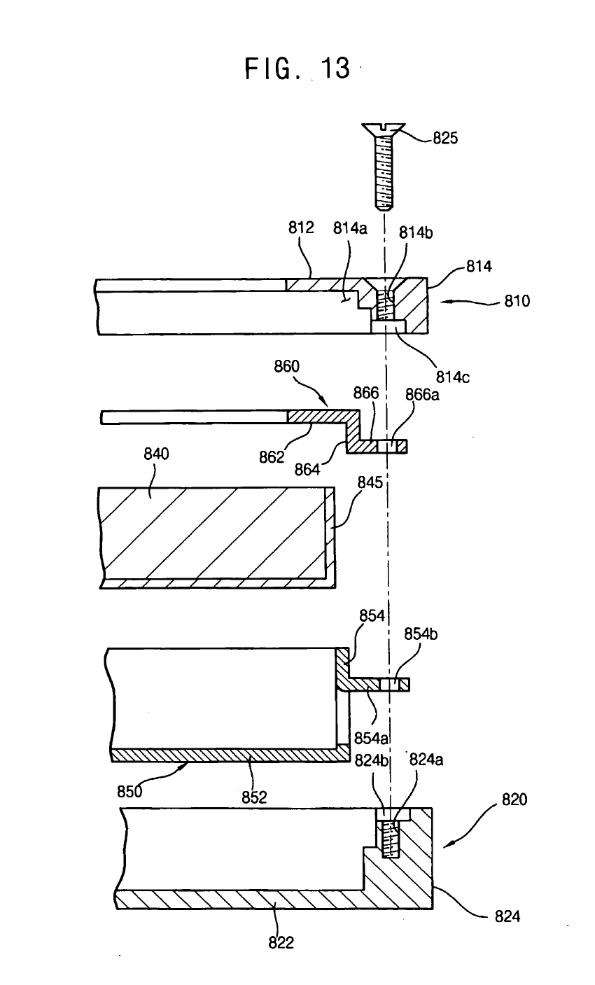

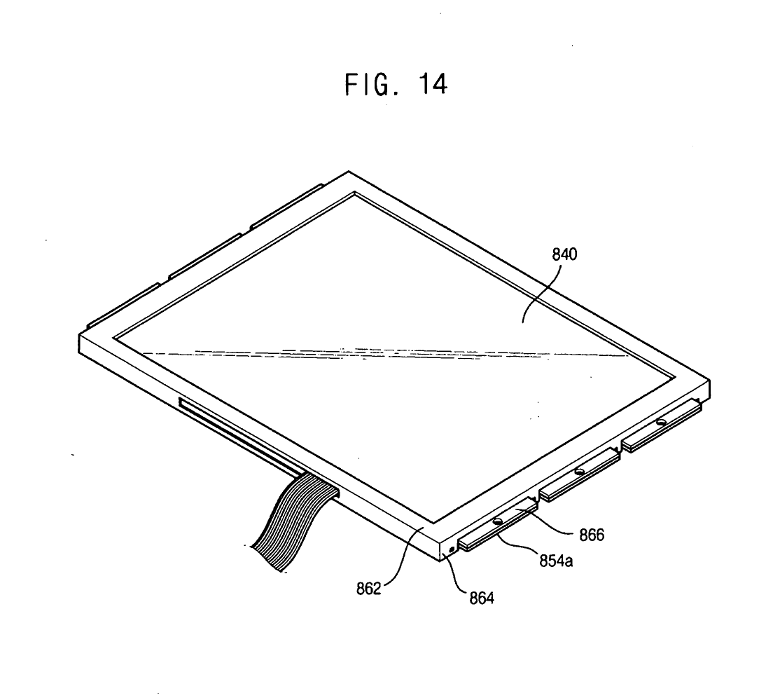

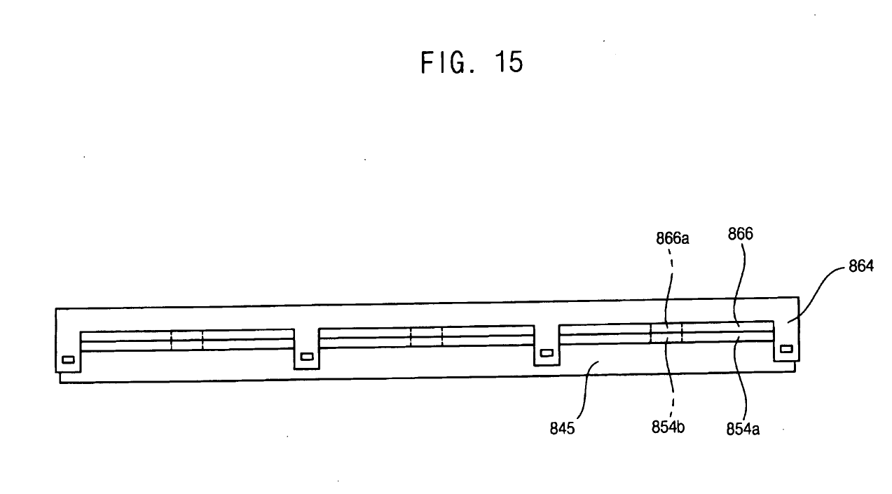

FIG. 12 is a cross-sectional view illustrating a display apparatus in accordance with still another embodiment of the present invention. FIG. 13 is an exploded cross-sectional view illustrating the display apparatus in FIG. 12. FIG. 14 is a perspective view illustrating the display apparatus in FIG. 12. FIG. 15 is a side view illustrating the display apparatus in FIG. 12:

Referring to FIGS. 12 to 15, a display apparatus 800 includes a housing unit 830, a display panel 840, a mold frame 845, a receiving container 850 and a chassis 860.

The housing unit 830 is configured to receive the display panel 840, the mold frame 845, the receiving container 850 and the chassis 860. The housing unit 830 includes a front case 810 and a rear case 820.

The front case 810 includes a first front case portion 812 and a second front case portion 814.

The first front case portion 812 has a substantially rectangular plate shape when viewed on a plane. The second front case portion 814 is in a peripheral region of the first front case portion 812. Front case portion 812 includes an opening 813 to expose an effective display region EDR3 of the display panel 840.

The second front case portion 814 is substantially perpendicular to the first front case portion 812. Additionally, second front case portion 814 includes a stepped portion 814a to fix the display panel 840, mold frame 845 and the receiving container 850 to the front case 810.

The rear case 820 includes a first rear case portion 822 and a second rear case portion 824.

The first rear case portion 822 has a substantially rectangular plate shape, and the second rear case portion 824 is in a peripheral region of the first rear case portion 822 and forms a receiving area. The second rear case portion 824 is substantially perpendicular to the first rear case portion 822.

The front case 810 is coupled to the rear case 820. Although many different embodiments are possible, in some embodiments front case 810 may be coupled to rear case 820 using a first coupling hole 814b formed through the second front case portion 814. A second coupling hole 824a is formed through the second rear case portion 824, at a position corresponding to the first coupling hole 814b. The first and second coupling holes 814b and 824a are coupled to, for example, a screw 825.

The second front case portion 814 of the front case 810 faces the second rear case portion 824 of the rear case 820. The display panel 840, the mold frame 845 and the receiving container 850 are positioned between the front case 810 and the rear case 820.

The receiving container 850 receives a mold frame 845, and the mold frame 845 receives the display panel 840. The receiving container 850 may include a metal plate, and the mold frame 845a may include a synthetic resin material or other appropriate material. The mold frame 845 prevents light from leaking through an opening formed by a first fixing portion (fixture) 854a formed at the receiving container 850 and a second fixing portion (fixture) 866 formed at the chassis 860.

The receiving container 850 includes a bottom face 852 and a sidewall 854. The bottom face 852 is on the first rear case portion 822 of the rear case 820, and the sidewall 854 is in a peripheral region of the bottom face 852. Therefore, a receiving area receiving the display panel 840 is formed on the bottom face 852. The sidewall 854 is formed in the peripheral region of the bottom face 852, and is substantially perpendicular to the bottom face 852.

The first fixing portion 854a is formed on the sidewall 854 of the receiving container 850. The fixing portion 854a has a substantially plate shape. The first fixing portion 854a is substantially perpendicular to the sidewall of the receiving container 850, and is substantially parallel to the bottom face 852.

In order to couple the receiving container 850 to the front case 810 and the rear case 720, a first fixing portion 854a is positioned between the second front case portion 814 and the second rear case portion 824. A first penetration hole 854b is formed through the first fixing portion 854a at a position corresponding to the first coupling hole 814b and the second coupling hole 824a to fix the first fixing portion 854a to the second front case portion 814 and the second rear case portion 824. In an embodiment incorporating a screw 825, the first fixing portion 854a is fixed between the second front case portion 814 and the second rear case portion 824 using the screw 825.

A first recess portion 814c is formed at the second front case portion 814 corresponding to the first fixing portion 854a to receive the first fixing portion 854a. A second recess portion 824b is formed at the second rear case portion 824 corresponding to the first fixing portion 854a to receive the first fixing portion 854a. In some embodiments, rather than including recessed portions in both second front case portion 814 or second rear case portion 824, a recess may be formed in one but not the other.

The mold frame 845 is positioned in the receiving container 850, and the display panel 840 is received in the mold frame 845. The display panel 840 includes a liquid crystal display panel configured to display an image using a liquid crystal material.

To prevent damage to display panel 840, the chassis 860 is coupled to the receiving container 850 to partially cover the display panel 840.

The chassis 860 includes a metal plate. The chassis 860 includes a first chassis portion 862 and a second chassis portion 864 having a second fixing portion 866.

The first chassis portion 862 is on an edge portion of the display panel 840 to prevent the separation of the display panel 840 from the receiving container 850.

The second chassis portion 864 is connected to the first chassis portion 862, and extends along a direction substantially parallel to the sidewall 854 of the receiving container 850. The second chassis portion 864 may be coupled to the receiving container 850 by a hooking method.

The second fixing portion 866 is formed on a portion of the second chassis portion 864, and is substantially parallel to the first chassis portion 862. The second fixing portion 866 is positioned between the second front case portion 814 and the second rear case portion 824. A second penetration hole 866b is formed through the second fixing portion 866 at a position corresponding to the first coupling hole 814b and second coupling hole 824a to fix the second fixing portion 866 to the second front case portion 814 and the second rear case portion 824. In embodiments incorporating a screw 825, the second fixing portion 866 is fixed between the second front case portion 814 and the second rear case portion 824 using the screw 825.

A first recess portion 814c and is formed at the second front case portion 814 corresponding to the first and second fixing portions 854a and 866 to receive the first and second fixing portions 866 and 866a. A second recess portion 824b is formed at the second rear case portion 824 corresponding to the first and second fixing portions 854a and 866 to receive the first and second fixing portions 854a and 866. In some embodiments, rather than including recessed portions in both second front case portion 814 and second rear case portion 824, a recess may be formed in one but not the other.

A first elastic member (not shown) is between the second front case portion 814 and the first fixing portion 854a. A second elastic member (not shown) is between the second fixing portion 866 and the second rear case portion 824. The first and second elastic members may include a flat-typed spring, a tensile spring, a compression spring, a damper, and/or other elastic apparatus.

According to the above, the display apparatus may have a relatively compact size.

Having described the exemplary embodiments of the present invention and its advantages, it is noted that various changes, substitutions and alterations can be made herein without departing from the spirit and scope of the invention as defined by appended claims. For example, many different embodiments are possible. In one example, portions of the apparatus may be coupled using techniques other than screw coupling (e.g., adhesive coupling or other mechanical coupling apparatus). In another example, the shapes of different constituents may be different than the exemplary shapes shown and described.

What is claimed is:

1. A display apparatus comprising:
a housing unit comprising a front case having an opening and a rear case being coupled to the front case; a display panel received in the housing unit, the display panel having a display area corresponding to the opening and a sidewall; and
a fixture member between the inner side face of the housing unit and the sidewall of the display panel, the fixture member fixing the display panel to the housing unit.

2. The display apparatus of claim 1, wherein the fixture member comprises a body portion on the sidewall of the display panel and a protruding portion protruding from the body and extending toward the inner side face of the housing unit.

3. The display apparatus of claim 2, wherein the housing unit further comprises a recessed portion corresponding to the protruding portion to receive the protruding portion.

4. The display apparatus of claim 3, wherein the recessed portion is included in the front case.

5. The display apparatus of claim 3, wherein the recessed portion of the housing unit is included in the rear case.

6. The display apparatus of claim 2, wherein the front case, the protruding portion and the rear case are coupled to each other by using a screw.

7. The display apparatus of claim 2, wherein the body is adhered to the display panel through an adhesive member.

8. A display apparatus comprising:
a housing unit comprising a front case including an opening and a rear case being coupled to the front case;
a receiving container in the housing unit, the receiving container comprising a sidewall unit comprising a sidewall and a fixture portion protruding from the sidewall and extended toward an inner side face of the housing unit; and
a display panel positioned in the housing unit, the display panel positioned in the housing unit so that a display area of the display panel is substantially aligned with the opening of the front case.

9. The display apparatus of claim 8, wherein the fixture portion of the sidewall unit is substantially perpendicular to the sidewall of the receiving container.

10. The display apparatus of claim 8, wherein the fixture portion is positioned between the front case and the rear case.

11. The display apparatus of claim 10, wherein the front case of the housing unit comprises a recess, and wherein the fixture portion of the sidewall is adjacent the recess.

12. The display apparatus of claim 10, wherein the rear case of the housing unit includes a recess, and wherein the fixture portion of the sidewall unit is positioned adjacent the recess.

13. The display apparatus of claim 8, wherein the front case of the housing unit, the fixture portion of the sidewall, and the rear case of the housing unit are coupled to each other using a screw.

14. The display apparatus of claim 8, further comprising an elastic member between the fixture portion of the sidewall unit and the housing unit.

15. The display apparatus of claim 14, wherein the elastic member comprises at least one selected from the group consisting of a flat-type spring, a tensile spring, a compression spring and a damper.

16. A display apparatus comprising:
a housing unit comprising a front case having an opening and a rear case being coupled to the front case;
a receiving container positioned in the housing unit, the receiving container comprising a sidewall;
a display panel positioned in the housing unit, the display panel including a display area positioned adjacent to the opening of the front case and an edge portion; and
a chassis comprising:
a first chassis portion positioned adjacent the edge portion of the display panel; and
a second chassis portion comprising a fixture portion extending from the first chassis portion along the sidewall of the receiving container, the fixture portion protruding toward an inner side face of the housing unit to be coupled to the housing unit.

17. The display apparatus of claim 16, wherein the fixture portion is substantially perpendicular to the second chassis portion.

18. The display apparatus of claim 16, wherein the fixture portion is positioned between the front case and the rear case.

19. The display apparatus of claim 18, wherein the front case comprises a recess, and wherein the fixture portion is positioned adjacent the recess.

20. The display apparatus of claim 18, wherein the rear case comprises a recess, and wherein the fixture portion is positioned adjacent the recess.

21. The display apparatus of claim 16, wherein the front case, the fixture portion, and the rear case are coupled to each other by using a screw.

22. The display apparatus of claim 16, further comprising an elastic member between the fixture portion and the housing unit.

23. The display apparatus of claim 22, wherein the elastic member comprises at least one selected from the group consisting of a flat-typed spring, a tensile spring, a compression spring and a damper.

24. A display apparatus comprising:
a housing unit comprising a front case having an opening and a rear case being coupled to the front case, the housing unit further comprising an inner side face;
a receiving container positioned in the housing unit, the receiving container comprising a sidewall unit comprising a sidewall and a first fixture portion protruding from the sidewall and extended toward the inner side face of the housing unit;
a display panel positioned in the housing unit, the display panel having a display area corresponding to the opening and an edge portion; and
a chassis comprising:
a first chassis portion positioned adjacent the edge portion of the display panel; and
a second chassis portion comprising a second fixture portion extending from the first chassis portion along the sidewall of the receiving container, the second fixture portion protruding toward the inner side face of the housing unit to be coupled to the housing unit.

25. The display apparatus of claim 24, wherein the first and second fixture portions are between the front case and the rear case.

26. The display apparatus of claim 24, wherein the first fixture portion faces the second fixture portion.

27. The display apparatus of claim 26, wherein the front case, the first fixture portion, the second fixture portion and the rear case are coupled to each other using a screw.

28. The display apparatus of claim 24, further comprising a first elastic member between the first fixture portion and the front case, and a second elastic member between the second fixture portion and the rear case.

29. A display apparatus comprising:
a display panel assembly including a display panel, the display panel configured to display an image in response to receiving one or more signals indicative of image information, the display panel assembly including a display area and a peripheral area, the display panel assembly including a fixture assembly adjacent the peripheral area;
a housing configured to house a display panel assembly, the housing comprising:
a first housing portion including an opening, the opening substantially aligned with the display area of the display panel;
a second housing portion attached to the first housing portion; and
wherein at least one of the first housing portion and the second housing portion are attached to the fixture assembly of the display panel assembly.

30. The apparatus of claim 29, wherein the housing does not include a window covering the opening.

31. The apparatus of claim 29, wherein the display panel assembly further includes another fixture assembly, and wherein the fixture assembly is positioned adjacent a first sidewall of the display panel and wherein the another fixture assembly is positioned adjacent a second sidewall of the display panel opposite the first sidewall.

32. The apparatus of claim 31, wherein at least one of the first housing portion and the second housing portion are attached to the fixture assembly and the another fixture assembly.

33. The apparatus of claim 29, wherein the first housing portion and the second housing portion are attached to the fixture assembly.

34. The apparatus of claim 33, wherein the first housing portion and the second housing portion are attached to the fixture assembly using a mechanical attachment apparatus.

35. The apparatus of claim 29, wherein the display panel assembly further comprises a receiving container, wherein the display panel is positioned in the receiving container and wherein the fixture assembly is attached to the receiving container.

36. The apparatus of claim 35, wherein the display panel assembly further comprises a mold frame positioned in the receiving container, and wherein the display panel is positioned in the mold frame.
